(19) United States
(12) Patent Application Publication
(10) Pub. No.: US 2006/0126706 A1
(43) Pub. Date: Jun. 15, 2006

(54) Auto-reboot modem

(76) Inventors: Kevin Brand, Marietta, GA (US); William Leech, Atlanta, GA (US)

Correspondence Address: SMITH FROHWEIN TEMPEL GREENLEE BLAHA, LLC, P.O. BOX 88148, ATLANTA, GA, 30356, US

(21) Appl. No.: 11/009,124

(22) Filed: Dec. 10, 2004

(51) Int. Cl. H04L 5/16

(52) U.S. Cl. 375/222

(57) ABSTRACT

Various embodiments of systems, methods, and modems are provided. One embodiment is a modem comprising: means for detecting when the modem loses communication with a network; and means for automatically rebooting the modem a predetermined number of times until communication is re-established with the network.

### BACKGROUND

Currently, there are various communication systems in which modems are employed for communicating between computer systems. In general, a modem is a device that converts data between digital form and analog form. The modem enables the computer system to transmit and receive data over a transmission medium (e.g., cable, telephone line, DSL line, power line, etc.). When sending data over the transmission medium, the modem modulates digital data received from the computer system into analog form for transmission over the medium. Similarly, when data in analog form is received via the transmission medium, the analog data is demodulated into digital information for processing by the computer system.

Modems are frequently used by customers for receiving data services from various service providers (e.g., Internet service providers). In this manner, the modem acts as an interface between the customer's computer(s) and a communication line terminating at equipment maintained by the service provider. Currently, there are various types of modems (e.g., dial-up modems, cable modems, digital subscriber line (DSL) modems, etc.) and associated data services. There exists, however, a significant problem with existing modems.

By way of example and with regard to DSL modems, it is very common for the modem to lose synchronization with the digital subscriber line access multiplexer (DSLAM) located at the central office. There are a number of reasons that the modem may lose synchronization with the DSLAM. For instance, the modem may lose synchronization (or otherwise lose communication with the DSLAM) due to scheduled maintenance on the DSLAM, glitches on the DSL line, glitches in the DSLAM, etc. In order to rectify the loss of synchronization, the customer may be forced to manually reboot the modem—which may become bothersome, frustrating, or at the very least undesirable. Furthermore, issues stemming from loss of synchronization may result in increased customer service costs for Internet services providers (ISPs).

### SUMMARY

Various embodiments of systems, methods, modems, etc. are provided for automatically rebooting a modem in response to detecting loss of communication with a network. One embodiment is a method for managing communication between a modem and a network. One such method comprises: establishing communication between a modem and a network; detecting that the modem has lost communication with the network; and automatically rebooting the modem.

Another embodiment is a modem comprising: a signal detector that determines whether the modem is in communication with a network; and a reboot module configured to automatically reboot the modem in response to the signal detector determining that the modem lost communication with the network. Another embodiment of a modem comprises: means for detecting when the modem loses communication with a network;

and means for automatically rebooting the modem a predetermined number of times until communication is re-established with the network.

Yet another embodiment comprises a digital subscriber line modem. One such DSL modem comprises: a signal detector that monitors a DSL line to determine when the modem loses communication with a DSLAM; and a reboot functionality in communication with the signal detector, the reboot functionality configured to automatically reboot the modem in response to the signal detector determining that the modem lost communication with the network.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a block diagram of an embodiment of a communication system in which an auto-reboot modem may be implemented.

FIG. 2 is a flow chart illustrating the general operation of an embodiment of the auto-reboot modem of FIG. 1.

FIG. 3 is a block diagram of an embodiment of an auto-reboot modem.

FIG. 4 is a flow chart illustrating the architecture, operation, and/or functionality of an embodiment of the automated reboot module of the modem of FIG. 3.

FIG. 5 is a flow chart illustrating the architecture, operation, and/or functionality of an embodiment of the loss-of-connectivity detector of the modem of FIG. 3.

FIG. 6 is a block diagram of another embodiment of a communication system in which an auto-reboot modem may be implemented.

### DETAILED DESCRIPTION

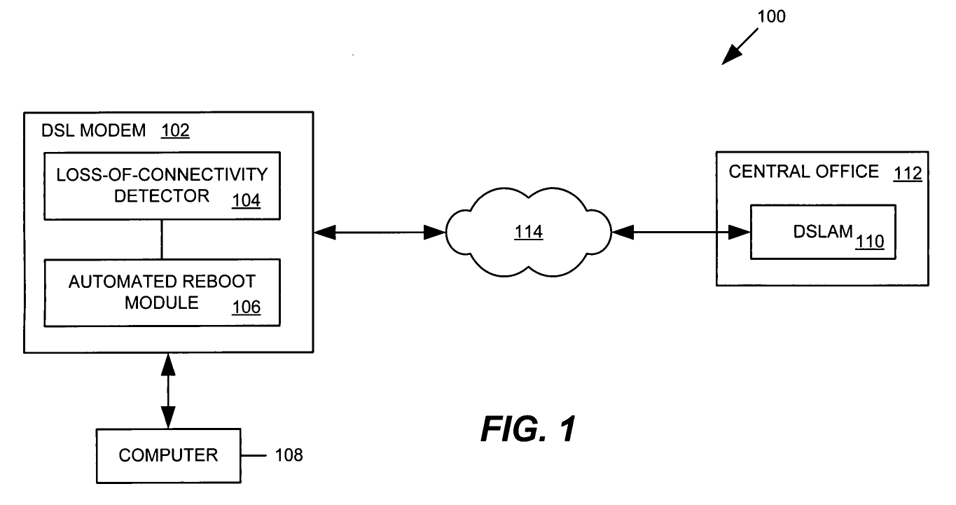

Various embodiments of systems, methods, modems, etc. are provided for automatically rebooting a modem in response to detecting loss of communication with a network. Several embodiments are described below with respect to FIGS. 1-6. As an introductory matter, however, the general operation of one exemplary embodiment of an auto-reboot modem will be briefly described.

In general, the exemplary auto-reboot modem comprises a mechanism for detecting when the modem loses communication with the associated network (e.g., telephone line, DSL line, cable, power line, etc.). When the modem loses synchronization, communication, etc., an auto-reboot algorithm is triggered which may automatically reboot the modem. The auto-reboot algorithm may be used as a secondary method of recovery after a primary means of recovery fails. Thus, it should be appreciated that the auto-reboot algorithm may be combined with other recovery means as desirable. In alternative embodiments, however, the auto-reboot algorithm may be implemented as the primary means of recovery as desired.

After the reboot is completed, the detection mechanism determines whether communication has been re-established. In some embodiments, the detection mechanism may wait a predetermined amount of time before performing the test to enable the reboot process, synchronization process, etc. to complete. In the event that communication is not re-established, the auto-reboot algorithm may attempt another reboot. For subsequent reboots, the detection mechanism may wait longer periods of time before performing the tests. In further embodiments, the auto-reboot algorithm may include a maximum number of reboot attempts to limit the number of reboot attempts. It should be appreciated that the auto-reboot algorithm may also collect information regarding loss of synchronization and/or the reboot attempts (e.g., success, failure, etc.) and share this information with, for example, the Internet service provider (ISP). In this manner, the ISP may collect, query, and/or display the information as desired.

FIG. 1 illustrates one embodiment of a system 100 in which one of a number of embodiments of an auto-reboot modem may be employed. In the embodiment of FIG. 1, system 100 provides a digital subscriber line (DSL) service to a customer premise (e.g., residential, business, etc.). In this regard, system 100 comprises a DSL modem 102 and a digital subscriber line access multiplexer (DSLAM) 110, which communicate with each other over a digital subscriber line via PSTN 114. As known in the art, DSLAM 110 may be located at a central office 112. DSL modem 102 provides the interface between a computer 108 and the digital subscriber line between the customer premise and DSLAM 110.

As further illustrated in FIG. 1, DSL modem 102 comprises a loss-of-connectivity detector (LOCD) 104 and an automated reboot module 106. In general, LOCD 104 and automated reboot module 106 provide the functionality for automatically rebooting DSL modem 102 when, for example, synchronization is lost with DSLAM 110 or DSL modem 102 otherwise loses communication over the DSL line. During operation of DSL modem 102, LOCD 104 monitors the DSL line to determine when communication has been lost.

Automated reboot module 106 comprises the logic, functionality, etc. for implementing a reboot algorithm in response to LOCD 104 detecting that communication has been lost.

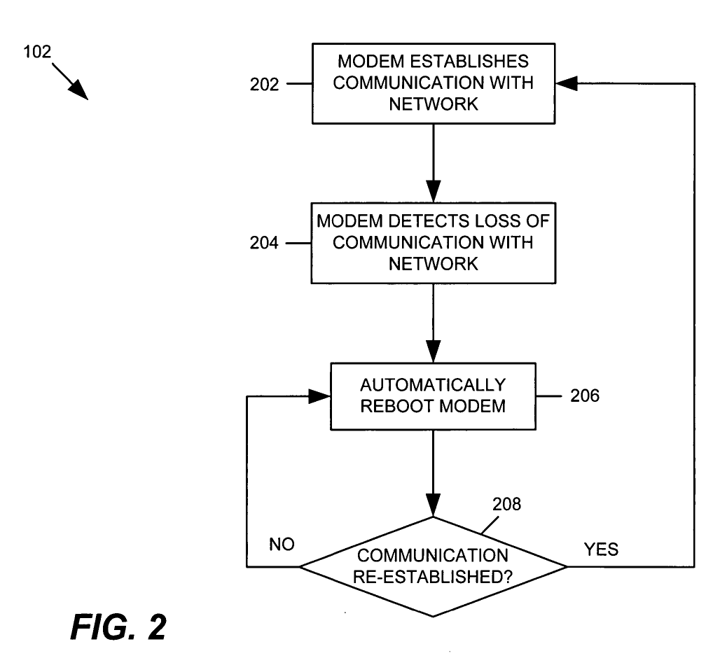

The general operation of DSL modem 102 is illustrated in the flow chart of FIG. 2.

At block 202, DSL modem 102 establishes communication via PSTN 114. For instance, DSL modem 102 may synchronize with DSLAM 110 or otherwise prepare the DSL line so that computer 108 may access DSL services. While the connection between DSL modem 102 and DSLAM 110 is active, computer 108 may access DSL services. At block 204, DSL modem 102 detects that the modem has lost communication, lost synchronization, etc. As described in more detail below, LOCD 204 provides this functionality. At block 206, LOCD 204 communicates with automated reboot module 106 to trigger the reboot process. At decision block 208, LOCD 204 determines whether communication has been re-established after the reboot process is completed. If communication is re-established, logical flow may return to block 202. If communication is not re-established, DSL modem 102 may be automatically rebooted again at block 206. As mentioned above and described in more detail below, the reboot algorithm implemented by automated reboot module 106 may be configured in various ways with, for example, suitable waiting intervals after the automatic reboot (and before determining whether communication is re-established), increasing waiting intervals for successive reboots, a reboot limit, etc.

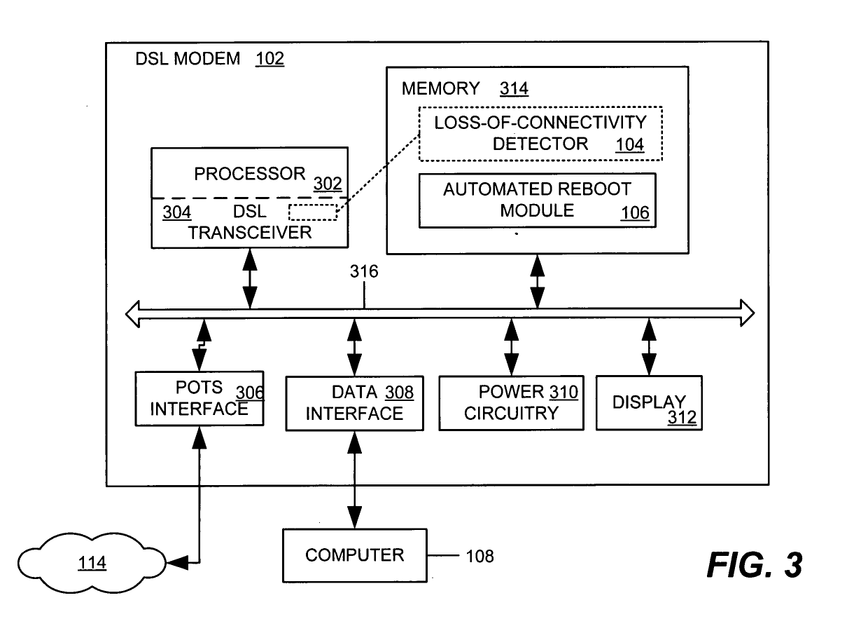

FIG. 3 illustrates a block diagram of one of a number of embodiments of DSL modem 102. In the embodiment of FIG. 3, DSL modem 102 comprises a processor 302 (which may be integrated with a DSL transceiver 304), a POTS interface 306, a data interface 308, power circuitry 310, a display 312, and memory 314, which are functionally interconnected via a local interface 316. As illustrated in FIG. 3, POTS interface 306 enables DSL modem 102 to connect to PSTN 114, while data interface 308 connects to computer 108. It should be appreciated that data interface 308 may support any suitable communication technology, transmission medium, protocol, etc.

As known in the art, power circuitry 310 includes the power components for providing power to DSL modem 102. Power circuitry 310 includes a switch that communicates with automated reboot module 106. In order to reboot DSL modem 102, automated reboot module 106 may send appropriate signals to control the switch and thereby reboot DSL modem 102. Display 312 may comprise a suitable display for providing visual notification regarding various aspects of DSL modem 102. For example, display 312 may comprise an LED display for communicating information regarding, for example, power, signal connectivity, etc.

Processor 302 may include any custom made or commercially-available processor, a central processing unit (CPU) or an auxiliary processor among several processors associated with DSL modem 102, a semiconductor based microprocessor (in the form of a microchip), a macroprocessor, one or more application-specific integrated circuits (ASICs), a plurality of suitably-configured digital logic gates, and other well known electrical configurations comprising discrete elements both individually and in various combinations to coordinate the overall operation of DSL modem 102. In this regard, it should be appreciated that processor 302 may include the logic, functionality, etc. of DSL transceiver 304. DSL transceiver 304 may be configured to support any type of DSL service, including, for example, symmetric DSL (SDSL), multirate DSL (MSDSL), G.shdsl, high bit rate DSL (HDSL), ISDN DSL (IDSL), and rate adaptive DSL (RADSL), to name a few. It should be appreciated that any existing or future DSL-related transmission methods may also be employed.

As illustrated in the embodiment of FIG. 3, the functionality of LOCD 104 may be implemented via DSL transceiver 304 and/or processor 302. Furthermore, logic associated with LOCD 104 may be located in memory 314. In this manner, DSL transceiver 304 may detect the loss of communication, synchronization, etc. and communicate this information to associated logic in memory 314 to trigger the auto-reboot process. As further illustrated in the embodiment of FIG. 3, memory 314 may include automated reboot module 106. Memory 314 may comprise any combination of volatile memory element(s) and/or nonvolatile memory element(s). One of ordinary skill in the art will appreciate that memory 314 may comprise other components which have been omitted for purposes of brevity.

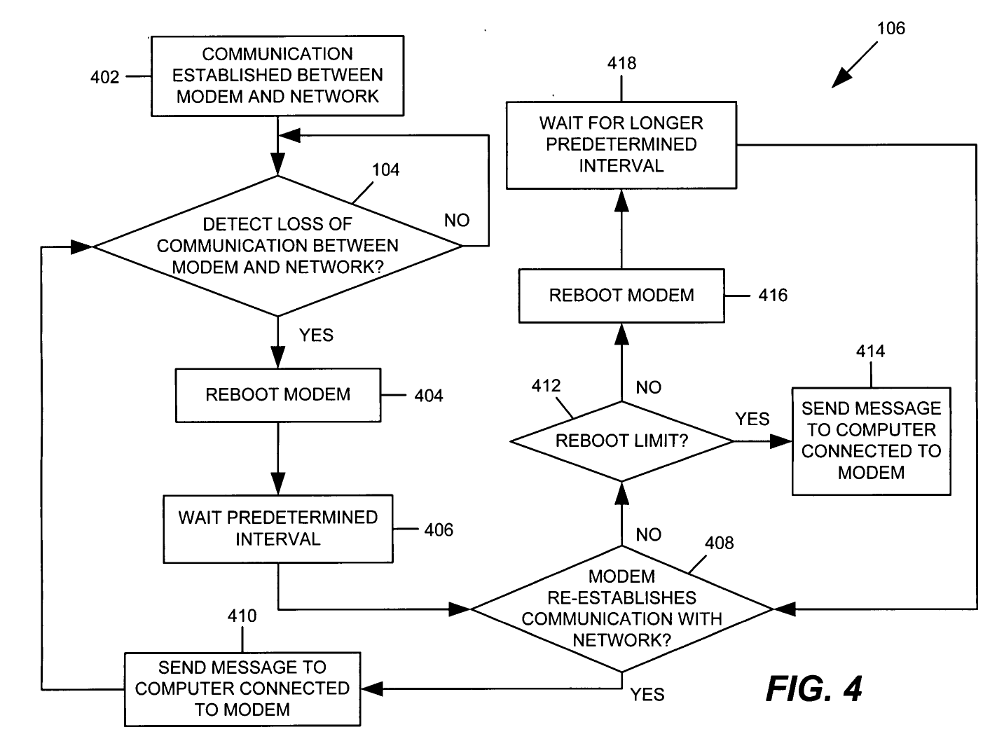

FIG. 4 illustrates the architecture, operation, and/or functionality of automated reboot module 106. At block 402, it is determined that communication has been established between DSL modem 102 and DSLAM 110. In other words, automated reboot module 106 may be initiated when DSL modem 102 is in operation. As illustrated by block 104 in FIG. 4, automated reboot module 106 may also be initiated, triggered, etc. when LOCD 104 detects that communication is lost between DSL modem 102 and DLSAM 110. In this regard, it should be appreciated that LOCD 104 and automated reboot module 106 are functionally connected. It should be appreciated, however, that the communication between these two logical components may be achieved in various ways. For example, in one embodiment, automated reboot module 106 may be called by LOCD 104 when communication loss is detected. In other embodiments, LOCD 104 may be called from within automated reboot module 106. It should be appreciated that other mechanisms, calling conventions, etc. may be used.

After loss of communication is detected by LOCD 104, at block 404, automated reboot module 106 reboots DSL modem 102. For example, as mentioned above, automated reboot module 106 may control a switch associated with power circuitry 310. In this manner, automated reboot module 106 may temporarily shutdown power to DSL modem 102 in response to LOCD 104 detecting that communication has been lost. One of ordinary skill in the art will appreciate that the reboot process may be initiated and implemented in a variety of alternative ways. The important aspect is that DSL modem 102 is rebooted.

At block 406, automated reboot module 106 may wait a predetermined amount of time before detecting whether communication is re-established. The waiting interval may be selected to coincide with the approximate amount of time corresponding to the reboot process for DSL modem 102. At decision block 408, LOCD 104 determines whether communication is re-established. If communication is re-established, at block 410, automated reboot module 106 may send an appropriate message to computer 108 (via data interface 308) informing a user that communication was lost but automatically re-established. The message may be seamlessly provided to computer 108 (e.g., without user knowledge) or, in alternative embodiments, may be provided as a desktop alert, pop-up window, etc. In alternative embodiments, automated reboot module 106 may provide appropriate information to a local file at computer 108 (or a remote file associated with the ISP) for later viewing by a technician and/or the customer. If communication is not re-established, automated reboot module 106 may determine (at decision block 412) whether a reboot limit has been reached. As mentioned above, automated reboot module 106 may employ a reboot limit to control the number of reboot attempts that are made.

If the reboot limit has been reached, at block 414, automated reboot module 106 may send an appropriate message to computer 108 (via data interface 308) informing a user that communication with DSLAM 110 has been lost, that an auto-reboot was attempted, that the reboot limit was reached, and/or that the auto-reboot was unsuccessful. If the reboot limit has not been reached, at block 416, automated reboot module 106 may initiate another reboot of DSL modem 102. As shown by block 418, for the second reboot (or subsequent reboots), automated reboot module 106 may wait for a longer period of time before determining whether communication has been re-established (decision block 408). In alternative embodiments, block 418 may be performed prior to rebooting at block 416.

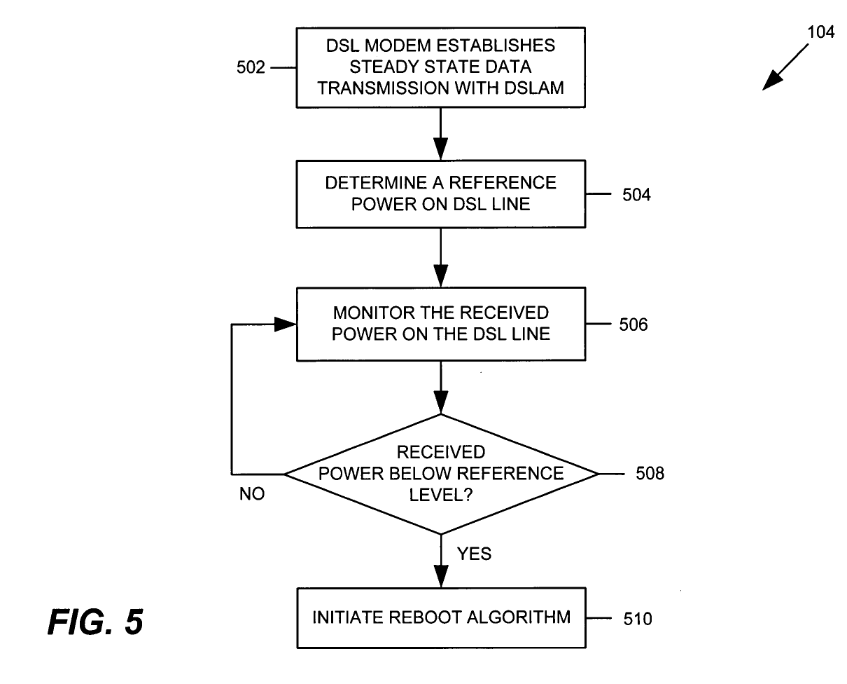

FIG. 5 illustrates the architecture, operation, and/or functionality of one of a number of embodiments of LOCD 104, which may be implemented in DSL modem 102. At block 502, DSL modem 102 establishes steady state data transmission with DSLAM 110. At block 504, LOCD 104 determines a reference power level on the DSL line. It should be appreciated that the reference power level provides a suitable base line for determining the steady state signal power level on the DSL line. At block 506, LOCD 104 monitors the received power on the DSL line. At decision block 508, LOCD 104 determines whether the received power falls below a predetermined threshold relative to the reference power level. If the received power falls below some suitable threshold, at block 510, LOCD 104 initiates the reboot sequence, algorithm, etc. It should be appreciated that various other methods may be used to detect loss of communication, synchronization, etc.

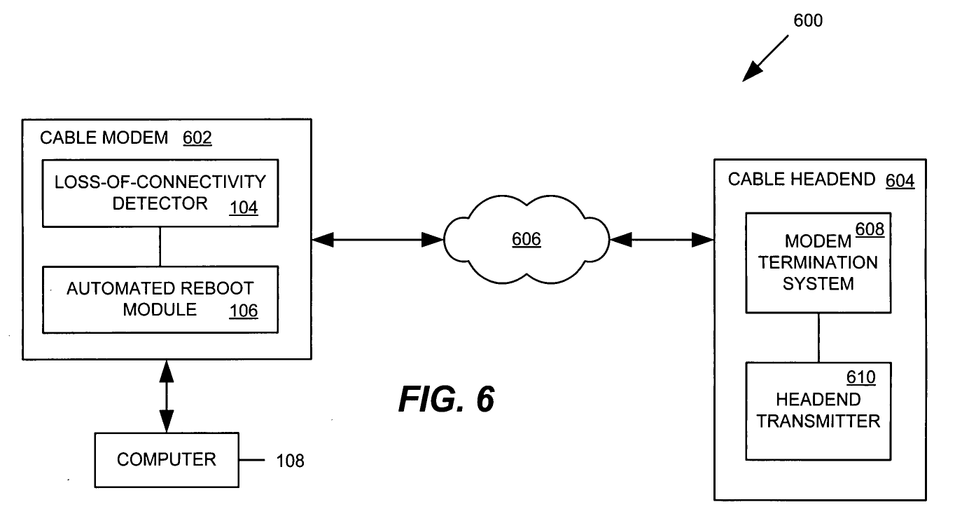

As mentioned above, LOCD 104 and automated reboot module 106 may be implemented in various communications systems. FIG. 6 illustrates another embodiment of a cable system 600 in which LOCD 104 and automated reboot module 106 are implemented in a cable modem 602 which communicates with a cable headend 604 via cable network 606.

One of ordinary skill in the art will appreciate that portions or all of LOCD 104 and automated reboot module 106 may be implemented in software, hardware, firmware, or a combination thereof. Accordingly, as illustrated in the embodiment of FIG. 3, portions or all of LOCD 104 and automated reboot module 106 are implemented in software or firmware that is stored in a memory and that is executed by a suitable instruction execution system. In hardware embodiments, the logic may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be further appreciated that the process descriptions or functional blocks in FIGS. 1-6 represent modules, segments, or portions of logic, code, etc. which include one or more executable instructions for implementing specific logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, portions or all of LOCD 104 and automated reboot module 106 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Although this disclosure describes various embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

What is claimed is:

1. A method for managing communication between a modem and a network, the method comprising:
establishing communication between a modem and a network;
detecting that the modem has lost communication with the network; and
automatically rebooting the modem.

2. The method of claim 1, further comprising determining whether the modem re-establishes communication with the network.

3. The method of claim 2, further comprising waiting a predetermined amount of time prior to determining whether the modem re-establishes communication with the network.

4. The method of claim 2, further comprising automatically rebooting the modem a second time if the modem does not re-establish communication with the network.

5. The method of claim 4, further comprising determining whether the modem re-establishes communication with the network after automatically rebooting the modem the second time.

6. The method of claim 5, further comprising waiting for another predetermined amount of time prior to determining whether the modem re-establishes communication with the network after automatically rebooting the modem the second time, the another predetermined amount of time larger than the predetermined amount of time.

7. The method of claim 1, wherein the establishing communication between the modem and the network comprises establishing communication between a digital subscriber line (DSL) modem and a digital subscriber line access multiplexer (DSLAM).

8. The method of claim 1, wherein the modem comprises one of a cable modem, a wireless modem, and a broadband power line modem.

9. The method of claim 1, further comprising providing information to a computer connected to the modem regarding the communication between the modem and the network.

10. A modem comprising:
a signal detector that determines whether the modem is in communication with a network; and
a reboot module configured to automatically reboot the modem in response to the signal detector determining that the modem lost communication with the network.

11. The modem of claim 10, wherein the signal detector determines whether communication with the network is re-established after the modem is rebooted.

12. The modem of claim 11, wherein the signal detector waits a predetermined amount of time prior to determining whether communication with the network is re-established.

13. The modem of claim 11, wherein the reboot module is further configured to automatically reboot the modem a second time if the signal detector does not re-establish communication with the network.

14. The modem of claim 13, wherein the signal detector determines whether the modem re-establishes communication with the network after automatically rebooting the modem the second time.

15. The modem of claim 14, wherein the signal detector waits for another predetermined amount of time prior to determining whether the modem re-establishes communication with the network after automatically rebooting the modem the second time.

16. A digital subscriber line modem comprising:
a signal detector that monitors a DSL line to determine when the modem loses communication with a DSLAM; and
a reboot functionality in communication with the signal detector, the reboot functionality configured to automatically reboot the modem in response to the signal detector determining that the modem lost communication with the network.

17. The digital subscriber line modem of claim 16, wherein the signal detector determines when the modem loses communication with the DSLAM by monitoring received power on the DSL line and determining when the received power is below a threshold power level.

18. The digital subscriber line modem of claim 16, further comprising a reboot algorithm which automatically reboots the modem a predetermined number of times until the signal detector determines that communication with the network is re-established.

19. The digital subscriber line modem of claim 18, wherein the reboot algorithm waits a predetermined amount of time after the modem is automatically rebooted before determining whether communication is re-established.

20. The digital subscriber line modem of claim 19, wherein the reboot algorithm waits a longer amount of time after each successive automatic reboot before determining whether communication is re-established.
